(19) United States
(12) Patent Application Publication
(10) Pub. No.: US 2007/0276657 A1
(43) Pub. Date: Nov. 29, 2007

(54) METHOD FOR THE TIME SCALING OF AN AUDIO SIGNAL

(75) Inventors: Philippe Gournay, Sherbrooke (CA); Claude LaFlamme, Orford (CA); Redwan Salami, St.-Laurent (CA)

Correspondence Address: MYERS BIGEL SIBLEY & SAJOVEC, PO BOX 37428, RALEIGH, NC, 27627, US

(73) Assignee: Technologies Humanware Canada, Inc.

(21) Appl. No.: 11/741,014

(22) Filed: Apr. 27, 2007

Related U.S. Application Data
(60) Provisional application No. 60/795,190, filed on Apr. 27, 2006.

(51) Int. Cl. G10L 19/02

(52) U.S. Cl. 704/203; 704/E21.017

(57) ABSTRACT

A method for the time scaling of a sampled audio signal is presented. The method includes a first step of performing a pitch and voicing analysis of each frame of the signal in order to determine if a given frame is voiced or unvoiced and to evaluate a pitch profile for voiced frames. The results of this analysis are used to determine the length and position of analysis windows along each frame. Once an analysis window is determined, it is overlap-added to previously synthesized windows of the output signal.

### RELATED APPLICATION

This application claims the benefit of and priority to U.S. Provisional Patent Application No. 60/795,190, filed Apr. 27, 2006, the disclosure of which is hereby incorporated herein by reference as if set forth in its entirety.

### FIELD OF THE INVENTION

The present invention relates to the field of audio processing and more particularly concerns a time scaling method for audio signals.

### BACKGROUND OF THE INVENTION

Time scale modification of speech and audio signals provides a means for modifying the rate at which a speech or audio signal is being played back without altering any other feature of that signal, such as its fundamental frequency or spectral envelope. This technology has applications in many domains, notably when playing back previously recorded audio material. In answering machines and audio books for example, time scaling can be used either to slow down an audio signal (to enhance its intelligibility, or to give the user more time to transcribe a message) or to speed it up (to skip unimportant parts, or for the user to save time). Time scaling of audio signals is also applicable in the field of voice communication over packet networks (VoIP), where adaptive jitter buffering, which is used to control the effects of late packets, requires a means for time scaling of voice packets.

There are a number of possible approaches, operating either in the time domain or frequency domain, to perform time scaling of speech or audio signals. Among all those approaches, SOLA (Synchronous Overlap and Add) is generally preferred for speech signals because it is very efficient in terms of both complexity and subjective quality.

SOLA is a generic technique for time scaling of speech and audio signals that relies first on segmenting an input signal into a succession of analysis windows, then synthesizing a time scaled version of that signal by adding properly shifted and overlapped versions of those windows. The analysis windows are shifted so as to achieve, in average, the desired amount of time scaling. In order to preserve the possible periodic nature of the input signal, however, the synthesis windows are further shifted so that they are as synchronous as possible with already synthesized output samples. The parameters used by SOLA are the window length, denoted herein as WIN_LEN, the analysis and the synthesis window shift respectively denoted as Sₐ and Sₛ, and the amount of overlap between two consecutive analysis and synthesis windows respectively denoted WOL_A and WOL_S.

Several realizations of SOLA have been presented since it was first proposed in 1985, some of which being presented in more detail below,

The Original SOLA Method

In the original presentation of SOLA (see S. Roucos, A. M. Wilgus, “High Quality Time-Scale Modification for speech”, Proceedings of the 1985 IEEE International Conference on Acoustics, Speech, and Signal Processing (ICASSP'85), vol. 2., Tampa, Fla., IEEE Press, pp. 493-496, Mar. 26-29, 1985.), the window length WIN_LEN, the analysis shift Sₐ, and the overlap between two adjacent analysis windows WOL_A, are set at algorithm development. They solely depend on the sampling frequency of the input signal. They do not depend on the properties of that signal (voicing percentage, pitch value). Moreover, they do not vary over time. The synthesis shift Sₛ is however adjusted so as to achieve, in average, the desired amount of time scaling:
Sₛ=αSₐ (1)

where α is the time scaling factor. Sₛ is further refined by a correlation maximization so that the new synthesis window is as synchronous as possible with already synthesized output samples. This process is illustrated in FIG. 1 (PRIOR ART).

As can be seen from FIG. 1, the major disadvantage of the original SOLA realization is that the amount of overlap between two consecutive synthesis windows WOL_S is not fixed and requires heavy computations. Besides, more than two synthesis windows may overlap at a given time. As mentioned in U.S. Pat. No. 5,175,769 (HEJNA et al.), “this complicates the work required to compute the similarity measure and to fade across the overlap regions”. Therefore, although SOLA was originally found to result in quality at least as high as earlier methods but at the cost of a much smaller fraction of the computations, it was still fairly perfectible.

The SOLAFS and WSOLA Methods

Referring to D. J. Hejna, “Real-Time Time-Scale Modification of Speech via the Synchronized Overlap-Add Algorithm”, Master's thesis, Massachusetts Institute of Technology, Apr. 28, 1990, and U.S. Pat. No. 5,175,769 (HEJNA et al), a modified SOLA method, named SOLAFS for “SOLA with Fixed Synthesis”, has been proposed to alleviate the main disadvantages of the original SOLA method. In SOLAFS, it is the analysis shift Sₛ which is fixed, and the analysis shift Sₐ which is adjusted so as to achieve, in average, the desired amount of time scaling. The analysis shift Sₐ is further refined by a correlation maximization so that the overlapping portions of the past and the new synthesis windows are as similar as possible.

SOLAFS is computationally more efficient than the original SOLA method because it simplifies the correlation and the overlap-add computations. However, SOLAFS resembles SOLA in that it uses mostly fixed parameters. The only parameter that varies is Sₐ, which is adapted so as to achieve the desired amount of time scaling. All the other parameters are fixed at algorithm development, and therefore do not depend on the properties of the input signal. Specifically, U.S. Pat. No. 5,175,769 (HEJNA et al.) states in col. 5, lines 65-66, that “the inventive (SOLAFS) method uses fixed segment lengths which are independent of local pitch”. WSOLA (Waveform Similarity Overlap-Add) is very similar to SOLAFS (see W. Verhelst, M. Roelands, “An overlap-add technique based on waveform similarity (WSOLA) for high quality time-scale modification”, Proceedings of the 1993 IEEE International Conference on Acoustics, Speech, and Signal Processing (ICASSP'93), pp. 554-557, 1993).

SAOLA, PAOLA and Other Variants

As another way to lower the computational complexity of SOLA and to alleviate the problem of a variable number of overlapping windows during the synthesis, it has been proposed to vary some of the SOLA parameters depending on the time scaling factor α. A first approach named SAOLA (Synchronized and Adaptive Overlap-Add), for example disclosed in S. Lee, H. D. Kim, H. S. Kim, “Variable Time-Scale Modification of Speech Using Transient Information”, Proceedings of the 1997 IEEE International Conference on Acoustics, Speech, and Signal Processing (ICASSP'97), vol. 2, Munich, Germany, IEEE Press, pp. 1319-1322, Apr. 21-24, 1997, consists in adapting the analysis shift Sₐ to the time scaling factor α:
Sₐ=WIN_{—}LEN/(2*α) (2)

Another approach named PAOLA (Peak Alignment Overlap-Add, see D. Kapilow, Y. Stylianou, J. Schroeter, “Detection of Non-Stationarity in Speech Signals and its application to Time-Scaling”, Proceedings of Eurospeech'99, Budapest, Hungary, 1999) consists in adapting both the window length WIN_LEN and analysis shift Sₐ to the time scaling factor α:
Sₐ=(Lₛₜₐₜ−SR)/|1−α| (3)
WIN_{—}LEN=SR+α*Sₐ (4)

where Lₛₜₐₜ is the stationary length, that is, the duration over which the audio signal does not change significantly (approx 25-30 ms), and SR is the search range over which the correlation is measured to refine the synthesis shift Sₛ. SR is set such that its value is greater than the longest likely period within the signal being time-scaled (generally about 12-20 ms).

Those two approaches (SAOLA and PAOLA) were later used in a subband (D. Dorran, R. Lawlor, E. Coyle, “Time-Scale Modification of Speech using a Synchronised and Adaptive Overlap-Add (SAOLA) Algorithm”, Audio Engineering Society 114th Convention 2003, Amsterdam, The Netherlands, preprint no. 5834, March 2003) and a hybrid approach combining SOLA with a frequency domain method (D. Dorran, R. Lawlor, E. Coyle, “High Quality Time-Scale Modification of Speech using a Peak Alignment Overlap-Add Algorithm (PAOLA)”, IEEE International Conference on Acoustics, Speech and Signal Processing, Hong Kong, April 2003).

Although Sₐ in SAOLA, and both WIN_LEN and Sₐ in PAOLA, depend on the desired amount of time scaling, it must be noted that those two parameters are, as in the original SOLA method, constant for a given amount of time scaling. Apart from that difference, the original SOLA method is applied without any change (fixed parameters).

Use of a Steady/Transient Classification

Some other modifications of the original SOLA method have been proposed to improve the quality and/or the intelligibility of time-scaled speech. In particular, it is well known that transient segments of speech signals are very important for intelligibility but very difficult to modify without introducing audible distortions. Hence, some authors proposed not to time scale transient segments (see D. Dorran, R. Lawlor, “An Efficient Time-Scale Modification Algorithm for Use within a Subband Implementation”, in Proc. Int. Conf. on Digital Audio Effects (2003), pp. 339-343; and D. Dorran, R. Lawlor, E. Coyle, “Hybrid Time-Frequency Domain Approach to Audio Time-Scale Modification”, J. Audio Eng. Soc., Vol. 54, No. 20 1/2, pp. 21-31, January/February, 2006). Apart from that difference, the original SOLA method was applied without any change (fixed parameters).

From the above, it appears that all of the prior time scaling methods based on SOLA use fixed parameters (apart of course from either Sₛ in SOLA and its variants, and Sₐ in SOLAFS and WSOLA, which are adjusted so as to achieve the desired amount of time scaling). Most importantly, the parameters used by all those methods do not depend on the properties of the input signal.

PSOLA and Variants

PSOLA (Pitch Synchronous Overlap and Add) and its variants such as TD-PSOLA (Time Domain PSOLA) constitute another important class of time domain techniques used for time scaling of speech. Despite the similarity in their name, they are however definitely not based on SOLA. Unlike SOLA, PSOLA requires an explicit determination of the position of each pitch pulse within the speech signal (pitch marks). The main advantage of PSOLA over SOLA is that it can be used to perform not only time scaling but also pitch shifting of a speech signal (i.e. modifying the fundamental frequency independently of the other speech attributes). However, pitch marking is a complex and not always reliable operation.

There therefore remains a need for a versatile time scaling technique which takes into consideration the properties of the signal itself without involving unduly burdensome calculations.

### SUMMARY OF THE INVENTION

Accordingly, the present invention provides a method for obtaining a synthesized output signal from the time scaling of an input audio signal according to a predetermined time scaling factor. The input audio signal is sampled at a sampling frequency so as to be represented by a series of input frames, each including a plurality of samples. The method includes, for each input frame, the following steps of:
a) performing a pitch and voicing analysis of the input frame in order to classify the input frame as either voiced or unvoiced. The pitch and voicing analysis further determines a pitch profile for the input frame if it is voiced;
b) segmenting the input frame into a succession of analysis windows. Each of these analysis windows has a length and a position along the input frame both depending on whether the input frame is classified as voiced or unvoiced. The length of each analysis window further depends on the pitch profile determined in step a) if the input frame is voiced; and
c) successively overlap-adding synthesis windows corresponding to the analysis windows.

A computer readable memory having recorded thereon statements and instructions for execution by a computer to carry out the method above is also provided.

Other features and advantages of the present invention will be better understood upon reading of preferred embodiments thereof with reference to the appended drawings.

### BRIEF DESCRIPTION OF THE DRAWINGS

FIG. 1 (PRIOR ART) is a schematized representation illustrating how the original SOLA method processes the input signal to perform time scale compression.

FIG. 2 (PRIOR ART) is a schematized representation illustrating how the SOLAFS method processes the input signal to perform time scale compression.

FIG. 3 is a schematized representation illustrating how a method according to an embodiment of the present invention processes the input signal to perform time scale compression.

FIG. 4 is a flowchart of a time scale modification algorithm in accordance with an illustrative embodiment of the present invention.

FIG. 5 is a flowchart of an exemplary pitch and voicing analysis algorithm for use within the present invention.

FIG. 6A illustrates schematically how the window length is determined and FIG. 6B illustrates schematically how the location of the analysis window is determined in an illustrative embodiment of the time scale modification algorithm in accordance with the present invention.

FIG. 7 is a flowchart showing how the location of an analysis window is determined in an illustrative embodiment of the time scale modification algorithm in accordance with the present invention.

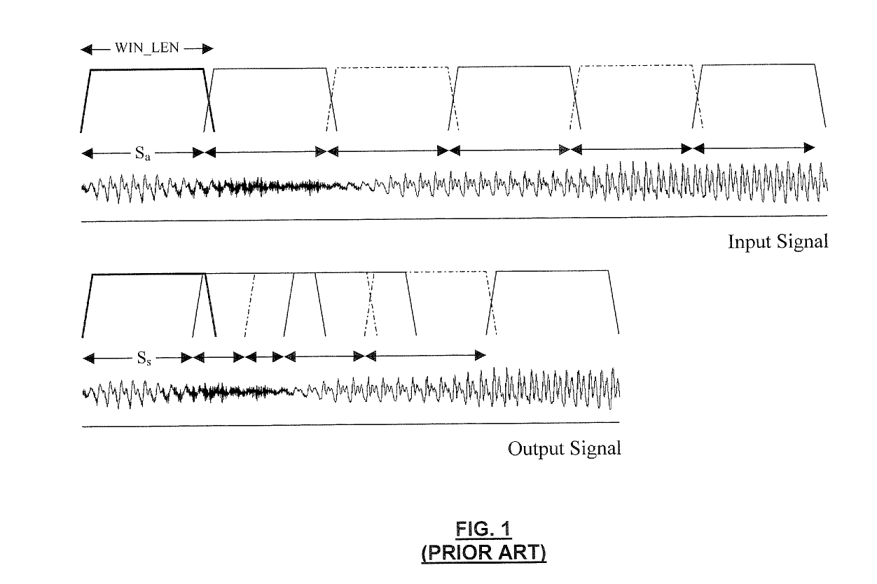

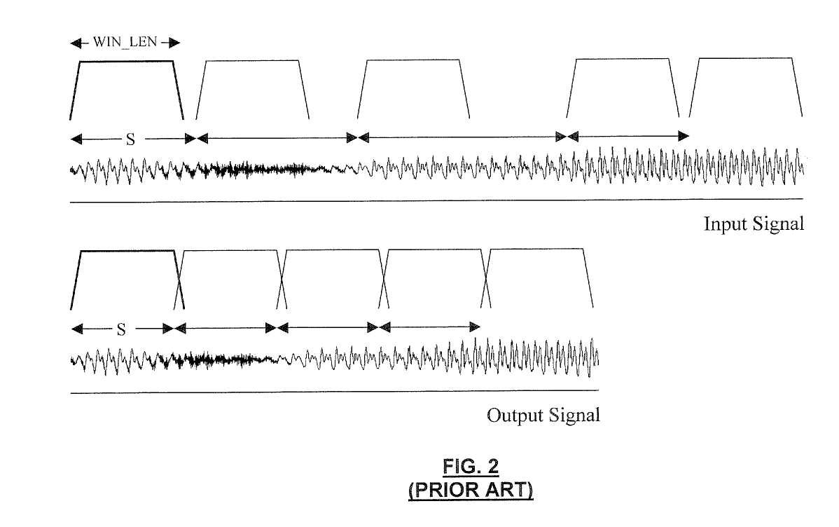

### DESCRIPTION OF PREFERRED EMBODIMENTS OF THE INVENTION

The present invention concerns a method for the time scaling of an input audio signal.

“Time scaling”, or “time-scale modification” of an audio signal refers to the process of changing the rate of reproduction of the signal, preferably without modifying its pitch. A signal can either be compressed so that its playback is speeded-up with respect to the original recording, or expanded, i.e played-back at a slower speed. the ratio between the playback rate of the signal after and before the time scaling is referred to as the “scaling factor” α. The scaling factor will therefore be smaller than 1 for a compression, and greater than 1 for an expansion.

It is understood that the input audio signal to be processed may represent any audio recording for which time scaling may be desired, such as an audiobook, a voicemail, a VoIP transmission, a musical performance, etc. The input audio signal is sampled at a sampling frequency. A digital audio recording is by definition sampled at a sampling frequency, but one skilled in the art will understand that the input signal used in the method of the present invention may be a further processed version of a digital signal representative of an initial audio recording. An analog audio recording can also easily be sampled and processed according to techniques well known in the art to obtain an input signal for use in the present method.

Some systems, for example those involving a speech or audio codec, operate on a frame by frame basis with a frame duration of typically 10 to 30 ms. Accordingly, the sampled input signal to which the present invention is applied is considered to be represented by a series of input frames, each including a plurality of samples. It is well known in the art to divide a signal in such a manner to facilitate its processing. The number of samples in each input frame is preferably selected so that the pitch of the signal over the entire frame is constant or varies slowly over the length of the frame. A frame of about 20 to 30 ms may for example be considered within an appropriate range.

The present invention provides a technique similar to SOLA and to some of its previously developed variants, wherein the parameters used by SOLA (window length, overlap, and analysis and synthesis shifts) are determined automatically based upon the properties of the input signal. Furthermore, they are adapted dynamically based upon the evolution of those properties.

Specifically, the value given to SOLA parameters depends on whether the input signal is voiced or unvoiced. That value further depends on the pitch period when the signal is voiced. The invention therefore requires a pitch and voicing analysis of the input signal.

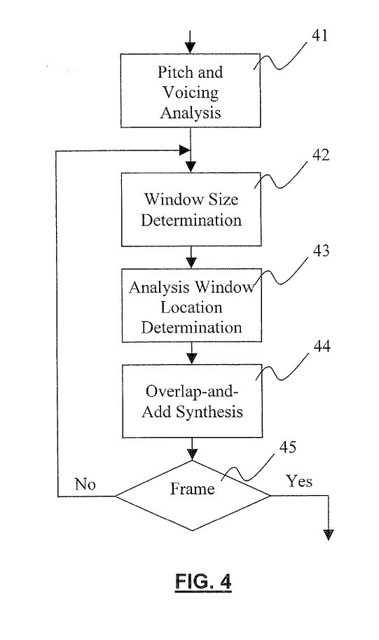

Referring to FIG. 4, there is shown a flow chart illustrating the steps of a method according to a preferred embodiment of the present invention, these steps being performed for each input frame of the input audio signal:
a) performing a pitch and voicing analysis 41 of the input frame in order to classify the input frame as either voiced or unvoiced. The pitch and voicing analysis further determines a pitch profile for the input frame if it has been classified as voiced;
b) segmenting the input frame into a succession of analysis windows. This preferably involves determining, for each analysis window, a window length 42, hereinafter denoted WIN_LEN, and a position along the input frame 43, which corresponds to the beginning of the window relative to the beginning of the input frame. Both the length and position of each analysis window depend on whether the input frame is classified as voiced or unvoiced. For input frames classified as voiced, the length of each analysis window further depends on the pitch profile determined in step a); and
c) successively overlap-adding synthesis windows corresponding to each analysis window 45, preferably as known from SOLA or one of its variants.

Each of the steps above will be further explained hereinbelow with reference to preferred embodiments of the present invention.

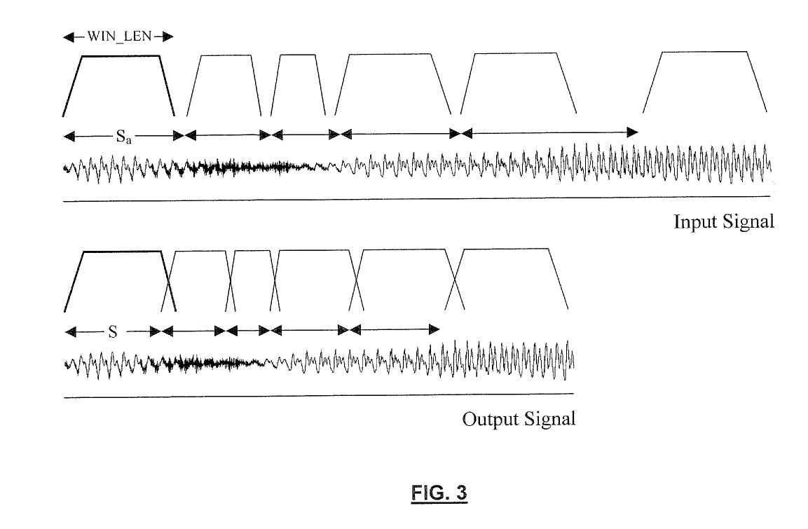

FIG. 3 shows how an illustrative embodiment of the time scale modification algorithm processes the signal to perform time scale compression. More particularly, FIG. 3 shows that although none of the parameters used by SOLA (particularly the window length and overlap duration) is constant, the analysis windows extracted from the input signal can be recombined at the synthesis stage to provide an output signal devoid of discontinuity that presents the desired amount of time scaling.

It will be understood by one skilled in the art that the steps of the present invention may be carried out through a computer software incorporating appropriate algorithms, run on an appropriate computing system. It will be further understood that the computing system may be embodied by a variety of devices including, but not limited to, a PC, an audiobook player, a PDA, a cellular phone, a distant system accessible through a network, etc.

Pitch and Voicing Analysis

As mentioned above, a purpose of the pitch and voicing analysis procedure is to classify the input signal into unvoiced (i.e. noise like) and voiced frames, and to provide an approximate pitch value or profile for voiced frames. A portion of the input signal will be considered voiced if it is periodical or “quasi periodical”, i.e. it is close enough to periodical to identify a usable pitch value. The pitch profile is preferably a constant value over a given frame, but could also be variable, that is, change along the input frame. For example, the pitch profile may be an interpolation between two pitch values, such as between the pitch value at the end of the previous frame and the pitch value at the end of the current frame. Different interpolation points or more complex profiles could also be considered.

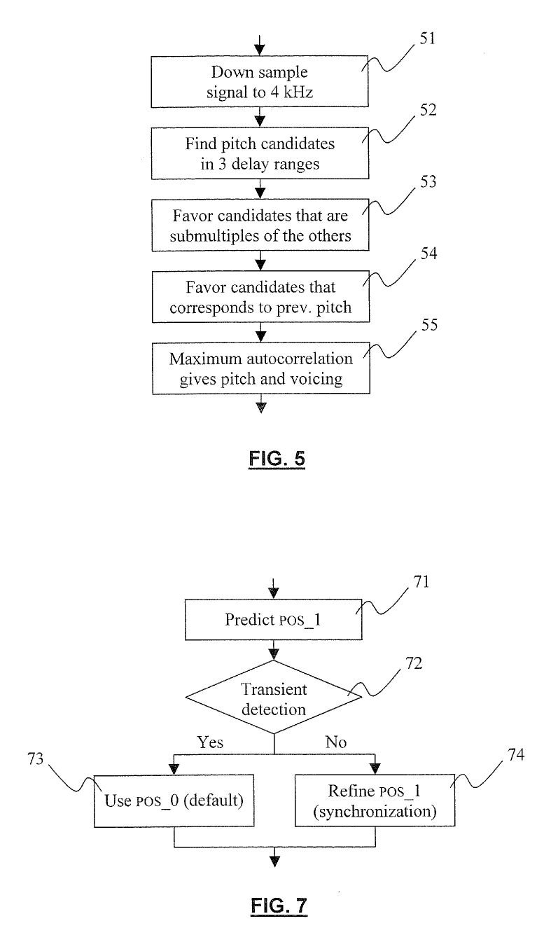

As will be readily understood by one skilled in the art, the present invention could make use of any reasonably reliable pitch and voicing analysis algorithm such as those presented in W. Hess, “Pitch Determination of Speech Signals: Algorithms and Devices”, Springer series in Information Sciences, 1983. With reference to FIG. 5, there is described one possible algorithm according to an embodiment of the present invention.

To save complexity, pitch and voicing analysis may be carried out on a down sampled version 51 of the input signal. Whatever the sampling frequency of the input signal, a fixed sampling frequency of 4 kHz will often be large enough to get an estimate of the pitch value with enough precision and a reliable classification.

An autocorrelation function of the down sampled input signal is measured using windows of an appropriate size, for example rectangular windows of 50 samples at a 4 kHz sampling rate, one window starting at the beginning of the frame and the other T samples before, where T is the delay. Three initial pitch candidates 52, noted T₁, T₂ and T₃, are the delay values that correspond to the maximum of the autocorrelation function in three non-overlapping delay ranges. In the current example, those three delay ranges are 10 to 19 samples, 20 to 39 samples, and 40 to 70 samples respectively, the samples being defined at 4 kHz sampling rate. The autocorrelation value corresponding to each of the three pitch candidates is normalized (i.e. divided by the square root of the product of the energies of the two windows used for the correlation measurement) then squared to exaggerate voicing and kept into memory as COR₁, COR₂ and COR₃ for the rest of the processing.

In order to favor pitch candidates that are a submultiple of one of the other pitch candidates 53, the autocorrelation values corresponding to each of the three pitch candidates are modified as follows:
if (abs(T₂*2−T₃)<7) then COR₂+=COR₃*0.35
if (abs(T₂*3−T₃)<9) then COR₂+=COR₃*0.35
if (abs(T₁*2−T₂)<7) then COR₁+=COR₂*0.35
if (abs(T₁*3−T₂)<9) then COR₁+=COR₂*0.35 (5)

where abs(•) denotes the absolute value. In order also to favor pitch candidates that correspond to the pitch candidates that were selected during the previous call to the pitch and voicing analysis procedure 54, the correlation values are further modified as follows:
if (abs(T₁−PREV_{—}T₁)<2) then COR₁+=PREV_{—}COR₁*0.15
if (abs(T₂−PREV_{—}T₂)<3) then COR₂+=PREV_{—}COR₂*0.15
if (abs(T₃−PREV_{—}T₃)<3) then COR₃+=PREV_{—}COR₃*0.15 (6)

where PREV_T₁, PREV_T₂ and PREV_T₃ are the three pitch candidates selected during the previous call of the pitch and voicing analysis procedure, and PREV_COR₁, PREV_COR₂ and PREV_COR₃ are the corresponding modified autocorrelation values.

The signal is classified as voiced when its voicing ratio is above a certain threshold 55. The voicing ratio is a smoothed version of the highest of the three modified autocorrelation values noted CORMAX and is updated as follows:
VOICING_RATIO=CORMAX+VOICING_RATIO*0.4 (7)

The threshold value depends on the time scaling factor. When this factor is below 1 (fast playback), it is set to 0.7, otherwise (slow playback) it is set to 1.

When the input signal is classified as voiced, the estimated pitch value T₀ is the candidate pitch that corresponds to CORMAX. Otherwise, the previous pitch value is maintained.

Once the voicing classification and pitch analysis have been completed, the three pitch candidates and the three corresponding modified autocorrelation values are kept in memory for use during the next call to the pitch and voicing analysis procedure. Note also that, before the first call of that procedure, the three autocorrelation memories are set to 0 and the three pitch memories are set to the middle of their respective range.

Determination of Window Length and Position

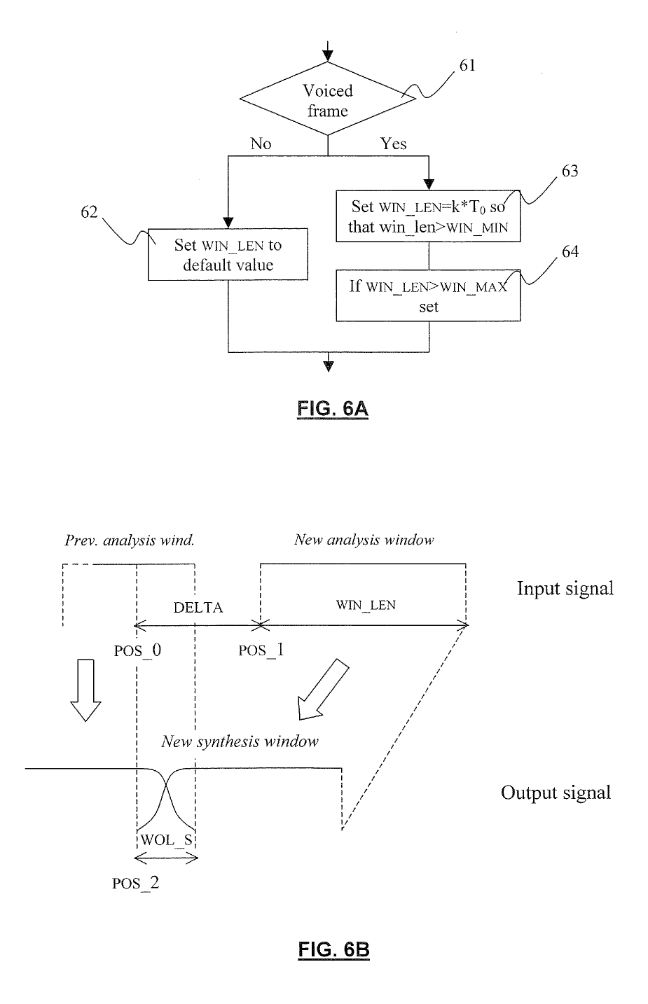

Referring to FIG. 6A, the determination of the window length according to a preferred embodiment of the invention is shown. The length WIN_LEN of the next analysis and synthesis windows, and the amount of overlap WOL_S between two consecutive synthesis windows, depend on whether the input signal is voiced or unvoiced 61. When the input signal is voiced, they also depend on the pitch value T₀.

In a first illustrative embodiment, the overlap between consecutive synthesis windows WOL_S is a constant, both over a given frame and from one frame to the next. For a sampling frequency of 44.1 kHz, a constant overlap of 110 samples for example may be adequate. Extension to a variable WOL_S should be easy to people skilled in the art and will be discussed further below.

For unvoiced frames, a default window length may be set 62. The window length may for example be set to a value that depends only on the sampling frequency. Alternatively, it may be set by default to the length of a previous analysis window. Good results are for example obtained when the window length WIN_LEN is equal to WIN_MIN=2*WOL_S. For a sampling frequency of 44.1 kHz this corresponds to WIN_LEN=220 samples.

For voiced frames, the pitch period represents the smallest indivisible unit within the speech signal. Choosing a window length that depends on the pitch period is beneficial not only from the point of view of quality (because it prevents the segmenting individual pitch cycles) but also from the point of view of complexity (because it lowers the computational load for long pitch periods). The window length WIN_LEN is preferably set to the smallest integer multiple of the pitch period T₀ that exceeds a certain minimum WIN_MIN 63. If the pitch profile is not constant, a representative value of the pitch profile may be considered as T₀. When the result is above a certain maximum WIN_MAX, it is clipped to that maximum 64. For example, for a sampling frequency of 44.1 kHz, a minimum window length WIN_MIN=220 is a reasonable choice. The maximum window length WIN_MAX is preferably set to PIT_MAX, where PIT_MAX is the maximum expectable pitch period.

Referring to FIG. 6B for a preferred embodiment of the invention, the position of the analysis window is then determined. In the preferred embodiment, at this stage, the pitch period T₀, the window length WIN_LEN and the overlap at the synthesis WOL_S are known. As shown in FIG. 6B, let POS_0 denote a start position corresponding to the beginning of the new analysis window if no time scaling were applied (specifically, POS_0 is the position of the last sample of the previous analysis window minus (WOL_S−1) samples). The location of the new analysis window is preferably determined based on POS_0 and on an additional analysis shift, the additional analysis shift depending on the window length WIN_LEN, on the overlap at the synthesis WOL_S, on the desired time scaling factor α, and on an accumulated delay DELAY which is defined with respect to the desired time scaling factor and is expressed in samples.

Referring to FIG. 7, there is shown how the position of a given analysis window is determined according to a preferred embodiment of the invention.

A prediction of the additional analysis shift DELTA required to achieve the desired amount of time scaling is ade 71. DELTA is preferably given by:
DELTA=(WIN_{—}LEN−WOL_{—}S)*α)−(WIN_{—}LEN−WOL_{—}S)+LIMITED_DELAY (8)

where LIMITED_DELAY is, for unvoiced frames, half the accumulated delay DELAY and, for voiced frames, the value of DELAY clipped to the closest value between minus T₀ and plus T₀. For voiced frames, this prediction of DELTA is rounded to an integer multiple of T₀, downwards when DELTA is positive and upwards when it is negative. This is done because we know that one can only insert or remove an integer multiple of pitch periods from the input signal.

Once a first prediction of POS_1=POS_0+DELTA has been obtained, a detection of transient sounds 72 is preferably performed to avoid modifying such sounds. Transient detection is based on the evolution of the energy of the input signal. Let ENER_0 be the energy (sum of the squares) per sample of the segment of WIN_LEN samples of the input signal finishing around POS_0, and ENER_1 be the energy per sample of a segment of WIN_LEN samples of the input signal finishing around POS_1. The input signal is classified as a transient when at least one of the following conditions is verified:
ENER_{—}1>ENER_{—}0*ENER_{—}THRES
ENER_{—}0>ENER_{—}1*ENER_{—}THRES
ENER_{—}0>PAST_{—}ENER*ENER_{—}THRES
PAST_{—}ENER>ENER_{—}0*ENER_{—}THRES
abs(POS_{—}1−POS_{—}0)<20 (9)

where abs(•) denotes the absolute value and PAST_ENER is the value taken by ENER_0 for the previous window. The reactivity of the time scaling operation is improved when the energy threshold ENER_THRES is a function of the time scaling factor α:
ENER_THRES=2.0 for α<1.5
ENER_THRES=3.0 for 1.5<α<2.5
ENER_THRES=3.5 for 2.5<α<3.5
ENER_THRES=4.0 for α>3.5 (10)

When the input signal is classified as a transient, POS_1 is set to POS_0 73, meaning that no time scaling will be performed for that window. Otherwise POS_1 is refined by a correlation maximization 74 between the WIN_LEN samples located after POS_0 and those located after POS_1, with a delay range around the initial estimate of POS_1 of plus to minus NN samples. The delay range NN depends on the local pitch period. For example, NN equal to 20% of the pitch period leads to a good compromise between complexity and precision of the resynchronization. Alternatively, a fixed range can be used. For example, when the sampling frequency is equal to 44.1 kHz, NN=40 samples is acceptable. A rectangular window is used for the correlation computation.

Alternatively, to reduce the complexity of the correlation operation, a first coarse estimate of the position POS_1 can be measured on the down sampled signal used for pitch and voicing analysis using a wide delay range (for example plus 8 to minus 8 samples at 4 kHz). Then that value of POS_1 can be refined on the full band signal using a narrow delay range (for example plus 8 to minus 8 samples at 44.1 kHz around the coarse position).

Overlap-and-Add Synthesis

Once the duration and location of the new analysis window have been determined, a new synthesis window is ready to be appended at the end of the already synthesized output signal. Returning to FIG. 6B, continuing with the example above, let POS_2 denote the position of the last sample of the previous synthesis window minus (WOL_S−1) samples. On FIG. 6B, POS_2 and POS_0 are artificially vertically aligned to show the correspondence between the previous analysis window and the past output samples. For the first WOL_S output samples after POS_2, the overlap-and-add procedure is applied:
output[POS_{—}2+n]=window[n]*output[POS_{—}2+n]+(1−window[n])*input[POS_{—}1+n] (11)

for n=0 to WOL_S−1, where window[•] is a smooth overlap window that comes from 1 for n=0 to 0 for n=WOL_S-1. For the remaining WIN_LEN−WOL_S samples, the input samples are simply copied to the output:
output[POS_{—}2+n]=input[POS_{—}1+n] for n=WOL_{—}S to WIN_{—}LEN−1. (12)

The first WIN_LEN−WOL_S new output samples (from POS_2 to POS_2+WIN_LEN−WOL_S−1) are ready to be played out. They can be played out immediately, or kept in memory to be played out once the end of the input frame has been reached. The last WOL_S synthesis samples however must be kept aside to be overlap-and-added with the next synthesis window.

Updates, Frame End Detection, and Initializations

In the embodiment described above, since the predicted position of the analysis window POS_1 does not necessarily correspond exactly to what is required to achieve the desired amount of time scaling, it is necessary to keep track of the accumulated delay (or advance) with respect to the desired amount of time scaling. This is done on a window per window basis by using the update equation:

$$DELAY = DELAY + {( WIN\_LEN - WOL\_S )}^{*} α - \\ ( POS\_ 1 + ( WIN\_LEN - WOL\_S ) - POS\_ 0 ) \qquad ( 13 )$$

That value can be further limited to within a certain range to limit the memory requirements of the algorithm. For a sampling frequency of 44.1 kHz for example limiting the accumulated delay to between minus 872 samples and plus 872 samples was found to not unduly affect the reactivity of the algorithm.

The positions of the end of the analysis and synthesis windows are also preferably updated using:
POS_{—}0=POS_{—}1+WIN_{—}LEN−WOL_{—}S
POS_{—}2=POS_{—}2+WIN_{—}LEN−WOL_{—}S (14)

When POS_0 is less than the frame length, a new window can be processed as described above. Otherwise, the end of the frame has been reached (step 45 of FIG. 4). In that case, the necessary number of past input and output samples is kept in memory for use when processing the next frame. If the output samples have been kept in memory, an output frame can be played out. Note that the size of that output frame is not constant and depends on the time scale factor and on the properties of the input signal. Specifically, for voiced signals, it depends on the number of pitch periods that have been skipped (fast playback) or duplicated (slow playback). In the case of a software implementation of the time scale modification algorithm according to the present invention, the variable output frame length must therefore be transmitted as a parameter to the calling program.

The variables DELAY, POS_0 and POS_2 and the memory space for the input and output signals are set to 0 before processing the first input frame. The pitch and voicing analysis procedure should also be properly initialized.

Variable Overlap

In the first illustrative embodiment of the present invention, described above, the overlap between consecutive synthesis windows is a constant that depends only on the sampling frequency of the speech signal. In a second embodiment, this overlap length is variable from frame to frame and depends on the pitch and voicing properties of the input signal. It can for example be a percentage of the pitch period, such as 25%. Use of longer overlap durations is justified when larger pitch values are encountered. This improves the quality of time scaled speech. A minimum overlap duration can be defined, for example 110 samples at 44.1 kHz. The value of the overlap between the previous synthesis window and the new synthesis window WOL_S is chosen after the pitch and voicing analysis, based on the voicing information and the pitch value. The overlap duration is preferably chosen so that no more than two synthesis windows overlap at a time. It can be chosen either before or after the determination of the length of the new window. Once the overlap duration is chosen, the rest of the time scaling operation is performed as described above.

In summary, the present invention solves the problem of choosing the appropriate length, overlap and rate for the analysis and synthesis windows in SOLA-type signal processing.

One advantage of this invention is that the analysis and synthesis parameters used by SOLA (window length, overlap, and analysis and synthesis shift) are determined automatically, based upon—among others—the properties of the input signal. They are therefore optimal for a wider range of input signals.

Another advantage of this invention is that those parameters are adapted dynamically, on a window per window basis, based upon the evolution of the input signal. They remain therefore optimal whatever the evolution of the signal.

Consequently, the invention provides a higher quality of time scaled speech than earlier realizations of SOLA.

As a further advantage, since the window length increases with the pitch period of the signal, the invention was found to require less processing power than earlier realizations of SOLA, at least for speech signals with long pitch periods.

Of course, numerous modifications could be made to the embodiments described above without departing from the scope of the present invention as defined in the appended claims.

1. A method for obtaining a synthesized output signal from the time scaling of an input audio signal according to a predetermined time scaling factor, the input audio signal being sampled at a sampling frequency so as to be represented by a series of input frames each including a plurality of samples, the method comprising, for each of said input frames, the steps of:
a) performing a pitch and voicing analysis of the input frame in order to classify said input frame as either voiced or unvoiced, said pitch and voicing analysis further determining a pitch profile for said input frame if said input frame is voiced;
b) segmenting the input frame into a succession of analysis windows, each of said analysis windows having a length and a position along the input frame both depending on whether the input frame is classified as voiced or unvoiced, the length of each analysis window further depending on the pitch profile determined in step a) if said input frame is voiced; and
c) successively overlap-adding synthesis windows corresponding to said analysis windows.

2. The method according to claim 1, wherein the pitch profile determined in step a) has a constant pitch value over said input frame.

3. The method according to claim 1, wherein the pitch profile determined in step a) is variable over said input frame.

4. The method according to claim 1, wherein the pitch and voicing analysis of step a) is performed on a down sampled version of said input frame.

5. The method according to claim 1, wherein, if the input frame is classified as unvoiced, step b) comprises setting the window length of each analysis window to a value based on the sampling frequency.

6. The method according to claim 1, wherein, if the input frame is classified as unvoiced, step b) comprises setting the window length of each analysis window to a value corresponding to the window length of a previous analysis window.

7. The method according to claim 1, wherein, if the input frame is classified as voiced, step b) comprises setting the window length to a smallest integer multiple of a pitch value within said pitch profile that exceeds a predetermined minimum window length.

8. The method according to claim 7, further comprising clipping the window length to a predetermined maximum window length if the smallest integer multiple of the constant pitch value exceeds said predetermined maximum window length.

9. The method according to claim 1, wherein step b) comprises predicting the position of each analysis window along the input frame from a start position, corresponding to a case where no time scaling is applied, with an additional analysis shift.

10. The method according to claim 9, wherein the additional analysis shift depends on the corresponding window length, the time scaling factor, a desired overlap between two consecutive synthesis windows, and an accumulated delay of the synthesis output signal with respect to the time scaling factor.

11. The method according to claim 10, wherein step c) comprises updating said accumulated delay after the overlap-adding of each synthesis window.

12. The method according to claim 10, wherein the additional analysis shift is predicted from:
DELTA=(WIN_{—}LEN−WOL_{—}S*α)−(WIN_{—}LEN−WOL_{—}S)−LIMITED_DELAY
where DELTA is the additional analysis shift, WIN_LEN is the window length, WOL_S is the desired overlap between two consecutive synthesis windows, α is the time scaling factor, and LIMITED_DELAY is set to half the accumulated delay if the input frame is unvoiced and set to the value of the accumulated delay clipped between negative and positive values of the pitch profile along the corresponding analysis window if the input frame is voiced.

13. The method according to claim 12, further comprising rounding the additional analysis shift as predicted to an integer multiple of a value of the pitch profile along said analysis window.

14. The method according to claim 9, wherein step b) further comprises detecting if the analysis window having the position as predicted contains transient sounds, and if so, resetting the position of the analysis window along the input frame to the start position.

15. The method according to claim 14, wherein step b) comprises refining the position of the analysis window as predicted as a function of a correlation between the synthesis window corresponding to said analysis window and an immediately preceding synthesized synthesis window.

16. The method according to claim 1, wherein an overlap between consecutive synthesis windows overlap-added in step c) is a constant over said input audio signal.

17. The method according to claim 16, wherein said overlap between consecutive synthesis windows is based on the sampling frequency.

18. The method according to claim 1, wherein an overlap between consecutive synthesis windows overlap-added in step c) is a variable over said input audio signal.

19. The method according to claim 18, wherein said overlap between consecutive synthesis windows for a given input frame depends on whether said input frame is classified as voiced or unvoiced, and further depends on the pitch profile determined in step a) if said input frame is voiced.

20. A computer readable memory having recorded thereon statements and instructions for execution by a computer to carry out a method for obtaining a synthesized output signal from the time scaling of an input audio signal according to a predetermined time scaling factor, the input audio signal being sampled at a sampling frequency so as to be represented by a series of input frames each including a plurality of samples, wherein the method comprises for each of said input frames, the steps of:
a) performing a pitch and voicing analysis of the input frame in order to classify said input frame as either voiced or unvoiced, said pitch and voicing analysis further determining a pitch profile for said input frame if said input frame is voiced;
b) segmenting the input frame into a succession of analysis windows, each of said analysis windows having a length and a position along the input frame both depending on whether the input frame is classified as voiced or unvoiced, the length of each analysis window further depending on the pitch profile determined in step a) if said input frame is voiced; and successively overlap-adding synthesis windows corresponding to said analysis windows.
